(19) United States
(12) Patent Application Publication
(10) Pub. No.: US 2023/0100725 A1
(43) Pub. Date: Mar. 30, 2023

(54) AIR VENT

(71) Applicant: fischer automotive systems GmbH & Co. KG, Horb a.N. (DE)

(72) Inventor: Gunter LEOPOLD, Baiersbronn (DE)

(21) Appl. No.: 17/947,618

(22) Filed: Sep. 19, 2022

(30) Foreign Application Priority Data
Sep. 29, 2021 (DE) 10 2021 125 251.2

(51) Int. Cl. B60H 1/34

(52) U.S. Cl. CPC B60H 1/3421; B60H 2001/3478

(57) ABSTRACT

Two parallel blades are disposed at a distance behind one another, in a flow direction, in an air vent for a motor vehicle, which are jointly pivoted in a manner opposite one another by way of a coupling device, and disposing, between the two blades, a louver comprising blades, which are disposed next to one another and can be jointly pivoted parallel to one another, perpendicularly to the two other blades.

### CROSS-REFERENCE TO RELATED APPLICATIONS

This application claims priority under 35 USC § 119 to German Patent Application No. 10 2021 125 251.2, filed Sep. 29, 2021, the entire disclosure of which is incorporated herein by reference.

### TECHNICAL FIELD

The invention relates to an air vent.

### DISCUSSION OF RELATED ART

Air vents are known, which are used in motor vehicles to supply air to a passenger compartment. Air vents typically comprise an air channel having an essentially arbitrary cross-section. The air vent or the air channel is usually disposed in a recessed manner in, for example, an instrument panel or a center console of the motor vehicle so that air flowing through the air channel flows into the passenger compartment. To be able to deflect an air current exiting the air vent laterally to the left and right and toward the top and bottom, which is to say, generally speaking, in a two-dimensional manner, known air vents comprise pivotable blades, for example.

Unexamined patent application DE 10 2006 002 663 A1 discloses an air vent comprising two louvers, which are disposed directly behind one another in a flow direction through the air vent and the blades of which are parallel to one another and can be jointly pivoted in opposite directions such that the blades of the two louvers can be pivoted from a central position, in which these are situated in a shared plane, toward both directions into positions that are angled with respect to one another. A louver comprises blades that are disposed at a distance with respect to one another and can be jointly pivoted parallel to one another. For the blades of the two louvers of the known air vent to jointly pivot in opposite directions, the blades are pivotably connected to one another at mutually facing edges of the blades.

Patent application EP 2 993 068 A1 discloses an air vent comprising three blades, which are disposed behind one another in a flow direction through the air vent and which, at the mutually facing edges thereof, are pivotably connected to one another. First pivot axes at the edges of first blades which are remote from the second and third blades, and close to an outflow opening of the air vent, are stationary, third pivot axes of third edges of the third blades which are remote from the first and second blades are immovable transversely to the flow direction and to the blades and are movable in the air vent for length compensation in the flow direction. For pivoting, the second blades are moved transversely to the flow direction and the blades, whereby the first and third blades are pivoted in opposite directions, and the second blades move parallel to one another without pivoting. Between the second blades, the known air vent comprises fourth blades, which are disposed perpendicularly to the other blades, and the fourth pivot axes of which extend perpendicularly through the second blades such that the air stream through the air vent can be guided perpendicularly to a direction in which the first and third blades guide the air current. The fourth blades are also moved during the movement of the second blades transversely to the flow direction.

### SUMMARY OF THE INVENTION

It is the object of the invention to provide an alternative air vent.

The air vent according to the invention comprises an air channel, having an inflow opening and an outflow opening, in which, for the purpose of guiding an air current through the air channel, three pivotable blades are disposed behind one another in a flow direction from the inflow opening through the air channel to the outflow opening. The air vent can also comprise one, two or three louvers, of which the blades are an integral part. A first blade is situated closest to the outflow opening, a third blade is situated closest to the inflow opening, and a second blade is situated between the first and third blades. The first blade can be pivoted about a first pivot axis, the second blade can be pivoted about a second pivot axis, and the third blade can be pivoted about a third pivot axis. The first and third blades are parallel to one another, which shall be understood to mean that longitudinal directions of the first and third blades, which extend through the air channel transversely to the flow direction, and the first and third pivot axes are parallel to one another. “Parallel” to one another shall not be understood to mean that the first and second blades are always situated in one plane or in mutually parallel planes, since the invention provides that the first and third blades are coupled to a coupling device such that these jointly pivot in opposite directions.

The second blade is arranged at an angle, preferably at a right angle, with respect to the first and third blades, as viewed in the flow direction through the air channel, wherein the longitudinal directions of the blades and the third pivot axis transversely to the flow direction through the air channel, and not surfaces of the blades, are decisive in terms of the angle of the second blade with respect to the first and third blades. The air current through the air vent can be guided in a different direction by pivoting of the second blade than by way of the first and third blades. In the case of a perpendicular arrangement of the second blade with respect to the first and third blades, as viewed in the flow direction through the air vent, the air current through the air vent is guided by way of the second blade perpendicularly to the direction in which the first and third blades guide the air current.

According to the invention, the third pivot axis, about which the third blade can be pivoted for guiding the air current through the air vent, is disposed closer to an edge of the third blade which faces the second blade than to an edge of the third blade which faces away from the second blade. This means that the third pivot axis is situated between a center and the edge of the third blade which faces the second blade, wherein it shall be understood that the center of an extension of the third blade in the flow direction through the air vent is meant. The third pivot axis is preferably situated at the edge of the third blade which faces the second blade, or at a distance of up to 20%, preferably up to 10%, of the extension of the third blade in the flow direction from the edge of the third blade which faces the second blade.

Moreover, the pivot axes about which the first and third blades can be pivoted for guiding the air current through the air vent are stationary with respect to the air channel of the air vent according to the invention, which is to say the pivot axes are not displaced in relation to the air channel. Preferably, the second pivot axis of the second blade is also stationary with respect to the air channel.

The second pivot axis can, for example, be arranged at a center of the second blade, wherein it shall be understood that a center of an extension of the second blade in the flow direction through the air vent is meant.

In one embodiment of the invention, the first pivot axis of the first blade can be disposed between a center of the first blade with respect to the extension thereof in the flow direction through the air vent and an edge of the first blade that is remote from the second and third blades or close to the outflow opening of the air channel. The first pivot axis is preferably disposed at the end of the second blade which is from the second and third blades and close to the outflow opening, or at a distance of up to 20%, preferably up to 10%, of the extension of the first blade, in the flow direction through the air vent, from the edge of the first blade which is remote from the second and third blades and close to the outflow opening of the air vent.

Preferably, the first and third blades are disposed at a distance with respect to one another in the flow direction through the air channel such that, in any pivot position of the two blades, air is able to flow through an intermediate space between the first and third blades from one side of the first blade to an opposite side of the third blade. The second blade is disposed in the intermediate space between the first and third blades, preferably extending through this intermediate space.

The first and/or third pivot axes are preferably situated at a center of the air channel, as viewed transversely to the flow direction through the air channel and transversely to the respective assigned blade. If the blades are oriented in the flow direction or in a longitudinal direction of the air channel, the blades, in this embodiment of the invention, are situated in a longitudinal center plane of the air channel which extends in the flow direction.

An embodiment of the invention provides a coupling rod, serving as the coupling device or as part of the coupling device, which is connected to the first and third blades in an articulated manner, and in each case at a radial distance with respect to the first and third pivot axes. The attachment points at which the coupling rod is connected to the first and third blades in an articulated manner are preferably situated on the opposing sides of the first and third blades. Instead of the coupling rod, the coupling device can also comprise a different, not rod-shaped coupling element, for example including mutually engaging teeth.

A preferred embodiment of the invention provides a louver comprising multiple second blades, which are disposed next to and at a distance with respect to one another, transversely to the flow direction through the air channel, and which can preferably be jointly pivoted parallel to one another about mutually parallel second pivot axes. In particular, the second blades can be pivoted in at least one pivot direction so far as to close the air channel. A position in which the second blades close the air channel is referred to as a blocking position here. In the blocking position, the second blades preferably overlap one another at the edges thereof in an imbricated manner. It is not necessary for the second blades to close the air channel in a hermetically sealed manner in the blocking position, but rather gaps and leakage areas between the second blades and the air channel are possible. The blocking position is characterized less by an air-tight closure of the air channel with respect to air flowing through than by, in particular the second blades, in the blocking position, overlapping one another at the edges thereof in an imbricated manner.

For pivoting the blades, an embodiment of the invention provides an operating element at the first blade, which is disposed at, close to or in the outflow opening of the air channel, so that the operating element can be gripped by a person sitting in a passenger compartment of a motor vehicle, in the instrument panel or center console of which, for example, the air vent is installed, and can be moved so as to pivot the blades. The operating element is non-rotatable with respect to the first blade so that the first blade can be pivoted about the first pivot axis as a result of pivoting of the operating element. The third blade, which is coupled to the first blade by the coupling device, pivots in a manner opposite that of the first blade due to the coupling. For pivoting the second blade, the operating element can be displaced parallel to the first pivot axis of the first blade.

For pivoting the second blade(s), a refinement of the invention provides a connector, which connects the operating element and the second blade or a second blade. The connector is mounted at the operating element or at the first blade so as to pivot about the first pivot axis, and is not displaceable with respect to the operating element in the direction of the first pivot axis, so that the connector, during a displacement of the operating element in the direction of the first pivot axis, is displaced along with the operating element, but is not pivoted along with the operating element when the same is pivoted. The displacement of the connector causes the second blade to pivot.

One embodiment of the invention provides that the connector engages on an end face of the second blade which faces a channel wall of the air channel of the air vent. As a result, it is not necessary to make a recess in the second blade for the connector, whereby the second blade(s) better close(s) the air channel in the blocking position.

The features and feature combinations, embodiments and configurations of the invention mentioned above in the description, and the features and feature combinations mentioned hereafter in the description of the figures and/or shown in a figure, can be used not only in the respective indicated or illustrated combination, but also in other essentially arbitrary combinations, or alone. Embodiments of the invention that do not include all the features of a dependent claim are possible. It is also possible to replace individual features of a claim with other disclosed features or feature combinations. Embodiments of the invention that do not include all the features of the exemplary embodiment, but an essentially arbitrary portion of the characterizing features of the exemplary embodiment, are possible.

### BRIEF DESCRIPTION OF THE DRAWINGS

The invention will be described hereafter in greater detail based on one exemplary embodiment shown in the drawings. In the drawings:

FIG. 1 shows a vertical longitudinal sectional view of an air vent according to the invention; and

FIG. 2 shows a perspective illustration of blades, a coupling device, and further built-in parts of the air vent from FIG. 1.

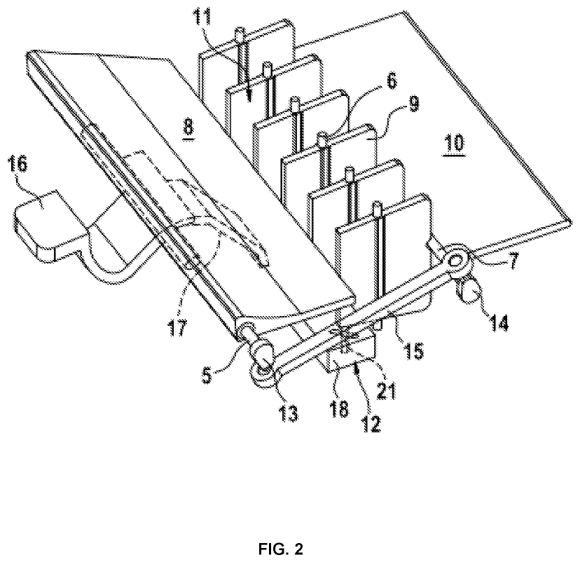

### DETAILED DESCRIPTION

The air vent 1 according to the invention shown in the drawing comprises a straight, rectangular tube-shaped housing, which forms an air channel 2 and is referred to as such hereafter. Other shapes of the air channel 2, for example having a round, not necessarily circular cross-section, having a cross-section that varies in shape and/or size across a length of the air channel 2 or a non-straight, but for example arcuate or angled air channel are possible (not shown). The air channel 2 includes an inflow opening 3 and an outflow opening 4 for air flowing through the air channel 2. For a recessed installation in, for example, an instrument panel or a center console of a motor vehicle, which is not shown, the air vent 1, is provided with the outflow opening 4 flush with a surface of the instrument panel, or of the center console, which faces a passenger compartment, for supplying air into the passenger compartment of the motor vehicle.

For guiding an air current through the air channel 2 or in the air channel 2 for the purpose of guidance in a direction in which the air current flows out of the air channel 2 through the outflow opening 4, the air vent 1 according to the invention comprises three blades 8, 9, 10, which can be pivoted about pivot axes 5, 6, 7 and which are disposed behind one another in the air channel 2 in a flow direction from the inflow opening 3 through the air channel 2 to the outflow opening 4.

Hereafter, a blade 8 that is disposed closest to the outflow opening 4 or at or in the outflow opening 4 is referred to as a first blade 8, and the pivot axis 5 thereof is referred to as a first pivot axis 5, a blade 9 closest to the inflow opening 3 is referred to as a third blade 9, and the pivot axis 7 thereof is referred to as a third pivot axis 7, and a blade 9 that is disposed between the first and third blades 8, 10 is referred to as a second blade 9, and the pivot axis 6 thereof is referred to as a second pivot axis 6. The blades 8, 9, 10 are strip-shaped elements, which extend through the air channel 2, transversely to the flow direction and transversely or vertically to the air channel 2, from one side to an opposite side or from top to bottom. A length of the blades 8, 9, 10 extends transversely to or through the air channel 2.

The first and third blades 8, 10 are individual blades, and the pivot axes 5, 7 thereof are parallel to one another and situated in a horizontal center longitudinal plane of the air channel 2. In a neutral or central position, the first and third blades 8, 10 are situated in the horizontal center longitudinal plane of the air channel 2. A neutral position denotes a pivot position of a blade 8, 9, 10 in which the blade 8, 9, 10 does not guide the flow through the air channel 2, which is to say, in the neutral position of the blade 8, 9, 10, air flows through the air channel 2 as it would flow through the air channel 2 in the absence of the blades 8, 9, 10 or in the absence of the respective blade 8, 9, 10. By pivoting of the blades 8, 9, 10 about the pivot axes 5, 6, 7 thereof, the air current through the air channel 2 is guided obliquely to one side or toward the top or bottom, whereby the direction of the air current flowing out of the air channel 2 through the outflow opening 4 is also guided. The terms “horizontal” and “vertical” refer to an intended installation and usage position of the air vent 1.

The pivot axes 5, 6, 7 are stationary with respect to the air channel 2, which is to say these are not displaced with respect to the air channel 2. The blades 8, 9, 10 can only be pivoted about the pivot axes 5, 6, 7 thereof, and can neither be rotated about a different axis or be moved in a translatory manner with respect to the air channel 2.

The first and third blades 8, 10 are located at a distance with respect to one another in the flow direction through the air channel 2, which is as large as the second blade 9 is wide. The width is an extension of the blade 9 in the flow direction through the air channel 2. As a result of the distance between the first and second blades 8, 10, an intermediate space 11 is formed between the first and third blades 8, 10, through which the second blade 9 extends. As viewed in the flow direction through the air channel 2, the second blade 9 extends through the air channel 2 perpendicularly to the first and third blades 8, 10, and as viewed in the flow direction through the air channel 2, the second pivot axis 6 of the second blade 9 extends perpendicularly to the first and third pivot axes 5, 7 of the first and third blades 8, 10. By pivoting about the second pivot axis 6, the second blade 9 thus deflects the air current through the air channel 2 perpendicularly to a direction in which the first and third blades 8, 10 deflect the air current.

The second blade 9 is an integral part of a so-called louver, which is to say the air vent 1 comprises multiple second blades 9, which are disposed at a distance with respect to one another, parallel next to one another, in the intermediate space 11 between the first and third blades 8, 10 in the air channel 2 of the air vent 1. Second pivot axes 6 of the second blades 9 are disposed parallel to one another in a transverse plane of the air channel 2.

The pivot axes 5, 7 of the first and third blades 8, 10 are situated at an edge of the blades 8, 10 on the outflow side, which is to say facing the outflow opening 4, which is to say the first pivot axis 5 of the first blade 8 is situated at an edge of the first blade 8 which is remote from the second and third blades 9, 10, and the third pivot axis 7 of the third blade 10 is situated at an edge of the third blade 10 which faces the second and first blades 8, 9. The second pivot axes 6 of the second blades 9 are situated in the middle of widths of the second blades 9, wherein the widths are the extension of the second blades 9 in the flow direction through the air channel 2.

The first and third blades 8, 10 jointly pivot in a manner opposite one another, for which purpose these are coupled to a coupling device 12. The coupling device 12 comprises an input pivot lever 13 and an output pivot lever 14 and a coupling rod 15. The input and output pivot levers 13, 14 each project radially with respect to the first or third pivot axis 5, 7, and rigidly from the first and third blades 8, 10, and are connected at the ends thereof which are remote from the particular blade 8, 10 in an articulated manner to the coupling rod 15. The input and output pivot levers 13, 14 project from opposing sides of the first and third blades 8, 10, whereby the first and third blades 8, 10 jointly pivot in a manner opposite one another.

The blades 8, 9, 10 are pivoted by hand. For this purpose, the air vent 1 according to the invention comprises an operating element 16, which is disposed at the first blade 8 that is arranged at or in the outflow opening 4 of the air channel 2. The operating element 16 is disposed so as to be accessible and movable from the passenger compartment of the motor vehicle, which is not shown. The operating element 16 is non-rotatable with respect to the first blade 8, so that the first blade 8 can be pivoted by pivoting of the operating element 16. As a result of being coupled to the first blade 8, the third blade 10 pivots along with the first blade 8 in a manner opposite thereto.

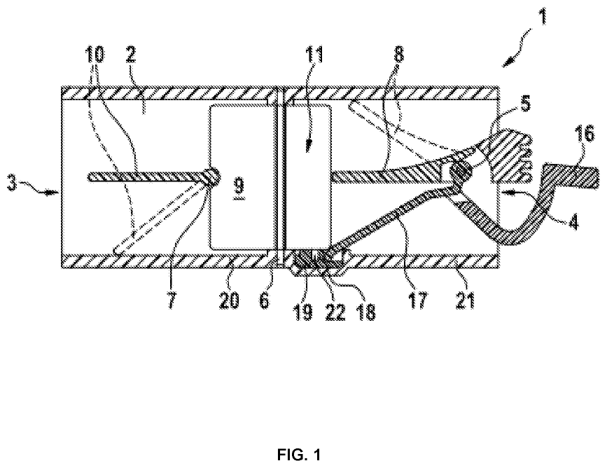

If the first and third blades 8, 10 are deflected, which is to say pivoted in relation to the neutral or central positions thereof, the third blade 10, which is closer to the inflow opening 3 of the air channel 2, guides a portion of the air current or, in the case of a full excursion with maximum deflection of the blades 8, 10, the entire air current through the air channel 2 obliquely from one side of the third blade 10, through the intermediate space 11 between the first and third blades 8, 10, onto an opposite side of the first blade 8. The maximum deflection or the full excursion of the first and third blades 8, 10 in a direction is illustrated in FIG. 1 by way of dotted lines. With a full excursion, edges of the first and third blades 8, 10 remote from the pivot axes 5, 7 rest against opposing walls of the air channel 2, so that the entire air current through the air channel 2, on one side, flows along the third blade 10 and through the intermediate space 11, to the opposing side of the first blade 8.

The operating element 16 is displaceably guided at the first blade 8 in the direction of the first pivot axis 5 such that the operating element 16 can be displaced in the direction of the first pivot axis 5, without the first blade 8 being displaced. From the operating element 16, a connector 17—which in the exemplary embodiment is strip-shaped and angled and/or curved twice or multiple times—projects to one of the second blades 9. The connector 17 is not displaceable with respect to the operating element 16 so that the connector 17 is displaced together with the operating element 16 in the direction of the first pivot axis 5. Moreover, the connector 17 can be pivoted about the first pivot axis 5 with respect to the operating element 16 and with respect to the first blade 8, whereby the connector 17 is not pivoted along with the operating element 16 and the first blade 8 when the same are pivoted.

The connector 17 leads to a slide 18, which is displaceably guided in a guide groove 19 in a channel wall 20 of the air channel 2, and in the exemplary embodiment in a bottom of the air channel 2, transversely to the air channel 2 such that the slide 18 is displaceable transversely to the air channel 2 as a result of a displacement of the connector 17 by way of the operating element 16. The slide 18 includes a slot 21 for each second blade 9, which extends obliquely—in the exemplary embodiment, at an angle of 45°—with respect to the longitudinal direction of the air channel 2. Pins 22, which project rigidly from the slide 18 at the end faces of the second blades 9 which face the channel wall 20, engage in the slots 21. The pins 22 project rigidly from the end faces of the second blades 9, parallel to and at a radial distance with respect to the second pivot axes 6. Displacement of the slide 18 causes the second blades 9 to be jointly pivoted parallel to one another about the second pivot axes 6 thereof.

In one direction, the second blades 9 can be pivoted into a blocking position, in which mutually neighboring second blades 9 overlap one another at the mutually facing edges thereof in an imbricated manner, thereby blocking air from flowing through the air channel 2. It is not precluded, but also not necessary, that the second blades 2 close the air channel 2 in an air-tight manner in the blocking position. The invention does not preclude air from flowing through leakage areas between the second blades 9 and between the second blades 9 and the channel walls 20 at the end faces and at longitudinal edges of outer second blades 9 in the blocking position of the second blades 9.

The second blades 9 are operatively connected to the operating element 16 via the connector 17 and the slide 18 such that the second blades 9 can be pivoted in the direction of the first pivot axis 5 of the first blade 8 as a result of the slide 18 being pivoted.

The connector 17 leads from the operating element 16, or from the first blade 8, to the slide 18, which is displaceably guided in the guide groove 19 in the channel wall 20 of the air channel 2, transversely to the air channel 2. The connector 17 thus leads to the end faces of the second blades 9 which face the channel wall 20 or between the end faces of the second blades 9 and the channel wall 20. For this reason, none of the second blades 9 have to be provided with a recess or the like for the connector 17 for pivoting of the second blades 9. This enhances the blocking of the air channel 2 in the blocking position of the second blades 9.

### LIST OF REFERENCE NUMERALS

Air vent
1 air vent
2 air channel
3 inflow opening
4 outflow opening
5 first pivot axis
6 second pivot axis
7 third pivot axis
8 first blade
9 second blade
10 third blade
11 intermediate space
12 coupling device
13 input pivot lever
14 output pivot lever
15 coupling rod
16 operating element
17 connector
18 slide
19 guide groove
20 channel wall
21 slot
22 pin

1. An air vent, comprising an air channel including an inflow opening and an outflow opening, comprising at least three blades, which are disposed behind one another in a flow direction through the air channel from the inflow opening to the outflow opening and can be pivoted for guiding an air current through the air channel, of which a first blade at the outflow opening which can be pivoted about a first pivot axis and a third blade at the inflow opening which can be pivoted about a third pivot axis are parallel to one another, and a second blade that can be pivoted about a second pivot axis is disposed between the first and third blades at an angle with respect to the first and third blades in the air channel, and comprising a coupling device, which couples the first blade to the third blade such that the first blade can be pivoted in a manner opposite that of the third blade, wherein the third pivot axis of the third blade is disposed, in the flow direction through the air channel, between a center of the third blade and an edge of the third blade which faces the second blade, and that the first and third pivot axes are stationary with respect to the air channel.

2. The air vent according to claim 1, wherein the second pivot axis of the second blade, in the flow direction through the air channel, is disposed at a center of the second blade and/or a first pivot axis of the first blade, in the flow direction through the air channel, is disposed between a center of the first blade and an edge of the first blade which is remote from the first and second blades.

3. The air vent according to claim 1, wherein the second pivot axis of the second blade is stationary with respect to the air channel.

4. The air vent according to claim 1, wherein the first and third blades are distanced from one another in the flow direction through the air channel, and that the second blade extends through an intermediate space between the first and third blades formed by the distance.

5. The air vent according to claim 1, wherein the first and third blades are coupled to a coupling rod, which is connected to the first and third blades in an articulated manner, and in each case at a radial distance with respect to the first and third pivot axes.

6. The air vent according to claim 1, wherein a plurality of second blades are disposed next to one another between the first and third blades in the flow direction through the air channel and so as to be jointly pivotable, the second blades being pivotable into a blocking position in which these close the air channel.

7. The air vent according to claim 1, wherein an operating element is disposed at the first blade, which is non-rotatable with respect to the first blade and displaceable parallel to the first pivot axis.

8. The air vent according to claim 1, wherein the operating element is operatively connected to the second blade by way of a connector, and that the connector is mounted at the first blade so as to be rotatable about the first pivot axis.

9. The air vent according to claim 8, wherein the connector engages on an end face of the second blade which faces a channel wall of the air channel of the air vent.
